(19) United States
(12) Patent Application Publication
(10) Pub. No.: US 2014/0109748 A1
(43) Pub. Date: Apr. 24, 2014

(54) Mouthpiece for Brass-Wind Musical Instrument

(71) Applicant: David Bruce Griffin, Toccoa, GA (US)

(72) Inventor: David Bruce Griffin, Toccoa, GA (US)

(21) Appl. No.: 14/139,114

(22) Filed: Dec. 23, 2013

Related U.S. Application Data
(63) Continuation-in-part of application No. 13/283,751, filed on Oct. 28, 2011.

(51) Int. Cl. G10D 9/02

(52) U.S. Cl. CPC G10D 9/026
USPC 84/398

(57) ABSTRACT

A mouthpiece for a musical instrument is provided that includes an upper section. The upper section has a rim that has an end face. A first angled section may extend from the rim to a side surface of the upper section.

### CROSS REFERENCE TO RELATED APPLICATION

This application is a continuation-in-part application and claims the benefit of U.S. application Ser. No. 13/283,751 filed on Oct. 28, 2011 and entitled, “Mouthpiece for Brass-Wind Musical Instrument.” U.S. application Ser. No. 13/283,751 is incorporated by reference herein in its entirety for all purposes.

### FIELD OF THE INVENTION

The present invention relates generally to a mouthpiece for use with brass-wind musical instruments. More particularly, the present application involves a mouthpiece that may have a rim with a concave shaped end face, an oval shaped outer perimeter, a rim width with a flat shaped end face, and/or a cup with a racetrack oval shaped outer perimeter.

### BACKGROUND

Musical instruments, such as brass instruments, include a mouthpiece which is the portion of the instrument to which the musician places his or her lips. The mouthpiece is responsible for a large portion of the resulting sound the instrument makes when performing. The typical mouthpiece includes a rim with a convex terminal end that is the surface the lips of the user actually contact. The mouthpiece defines a bore that extends completely through from one end to the other. A cup is provided in the mouthpiece that is cone shaped and transitions to a throat portion that is smaller in diameter. A backbore extends through a shank of the mouthpiece that defines the lower end of the mouthpiece.

The cup of the mouthpiece can have either a semi-spherical shape or a conical shape. The shape of the cup may have an effect on the tone that is ultimately projected. A semi-spherical shaped cup may produce a tone with more definition than a cup that is conical in shape. Further, the depth of the cup has an effect on the range of tone that can be generated by the instrument. It is also known to vary the width of the rim of a mouthpiece in order to change how the mouthpiece will perform. A rim that is wide reduces the amount of pressure that the musician needs to apply to the mouthpiece thus increasing the amount of time the musician can perform by decreasing his or her strain in playing the instrument. However, increasing the width of the rim reduces the ability of the musician to produce different sounds with the mouthpiece.

One modification of a mouthpiece for brass instruments involves the provision of a counter bore located between the throat and the backbore. The throat is a generally narrow passage and the counter bore is wider than the throat such that the air-flow path extending through the mouthpiece widens upon exiting the throat and entering the counter bore. From the counter bore, the air-flow path extends into the backbore of the mouthpiece. This arrangement is said to amplify sounds prior to entering the backbore so that the musician can achieve higher notes with increased ease while maintaining the same feel of a conventional mouthpiece.

Another variation of mouthpiece design seeks to achieve a mouthpiece that is physically easier to play by the user and reduces the difficulty of high-register playing. This mouthpiece design includes an asymmetric lip restrictor that is in the form of a convex surface located within the cup. The user will attach the mouthpiece to the instrument so that the convex surface is positioned at the bottom lip of the user during use. The upper portion of the cup does not include the convex surface.

Although various attempts at improving the performance of mouthpieces used on brass instruments have been made, there still remains a need for a mouthpiece that reduces strain on the embouchure and is easier for the user to play. Previous designs have allowed for those with braces or false teeth to continue playing. Prior designs may lack the incorporation of a broad range of players, who, having the desire to play professionally, cannot, because their tone or range is lacking when they use any of the current mouthpieces on the market. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a front elevation view of a mouthpiece in accordance with one exemplary embodiment.

FIG. 2 is a side elevation view of the mouthpiece of FIG. 1.

FIG. 3 is a top view of the mouthpiece of FIG. 1.

FIG. 4 is a top view of the mouthpiece of FIG. 1 that illustrates different reference numbers from those illustrated in FIG. 3.

FIG. 5 is a cross-sectional elevation view taken along line 5-5 of FIG. 2.

FIG. 6 is a cross-sectional elevation view taken along line 6-6 of FIG. 1.

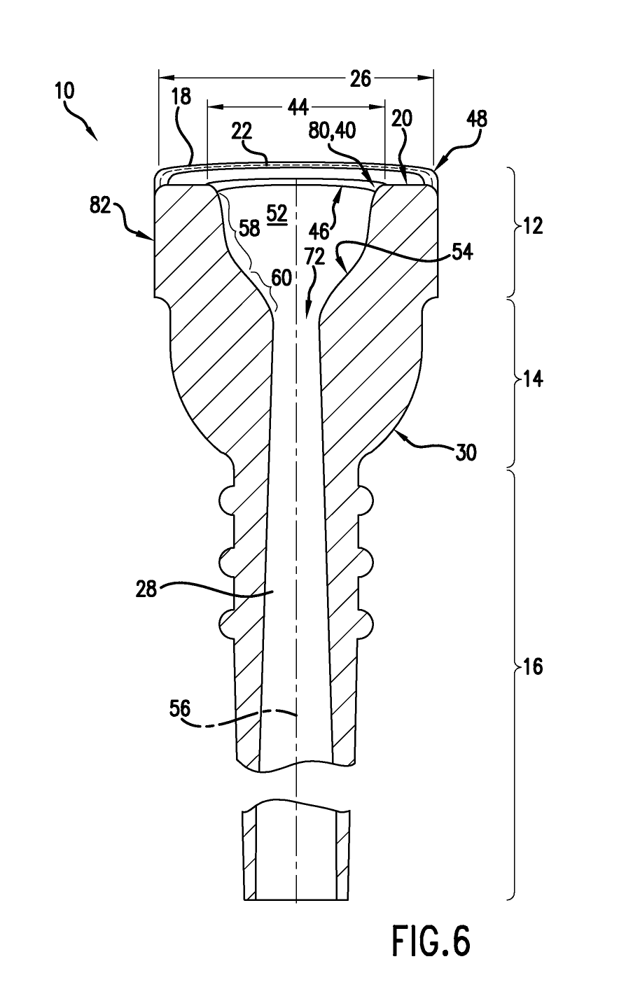

FIG. 7 is a cross-sectional view taken along line 7-7 of FIG. 1.

FIG. 8 is a cross-sectional view taken along line 8-8 of FIG. 1.

FIG. 9 is a cross-sectional view taken along line 9-9 of FIG. 1.

FIG. 10 is a side view of a mouthpiece in accordance with another exemplary embodiment.

FIG. 11 is a front view of the mouthpiece of FIG. 10.

FIG. 12 is a cross-sectional view taken along line 12-12 of FIG. 11.

FIG. 13 is a cross-sectional view taken along line 13-13 of FIG. 11.

FIG. 14 is a cross-sectional view of an alternative exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a mouthpiece 10 that may be used with brass instruments in order to play music. The mouthpiece 10 may be arranged so that the musician may reach higher notes even if he or she lacks the normal embouchure to do so. The mouthpiece 10 may be easier to use, may increase comfort on the musician's lips, and may reduce fatigue on his or her embouchure. A cup 52 that can be oval in shape may be included in the mouthpiece 10 in some embodiments, along with a rim 18 that has an oval shaped outer perimeter 18. In other embodiments, the mouthpiece 10 may include a rim 18 with an end face 20 that is concave in shape. Still further arrangements of the mouthpiece exist in which the width 50 of the end face 20 of the rim 18 is flat in shape upon extending from a round 48 of an outer perimeter 22 to a round 46 of an inner perimeter 40 of the rim 18.

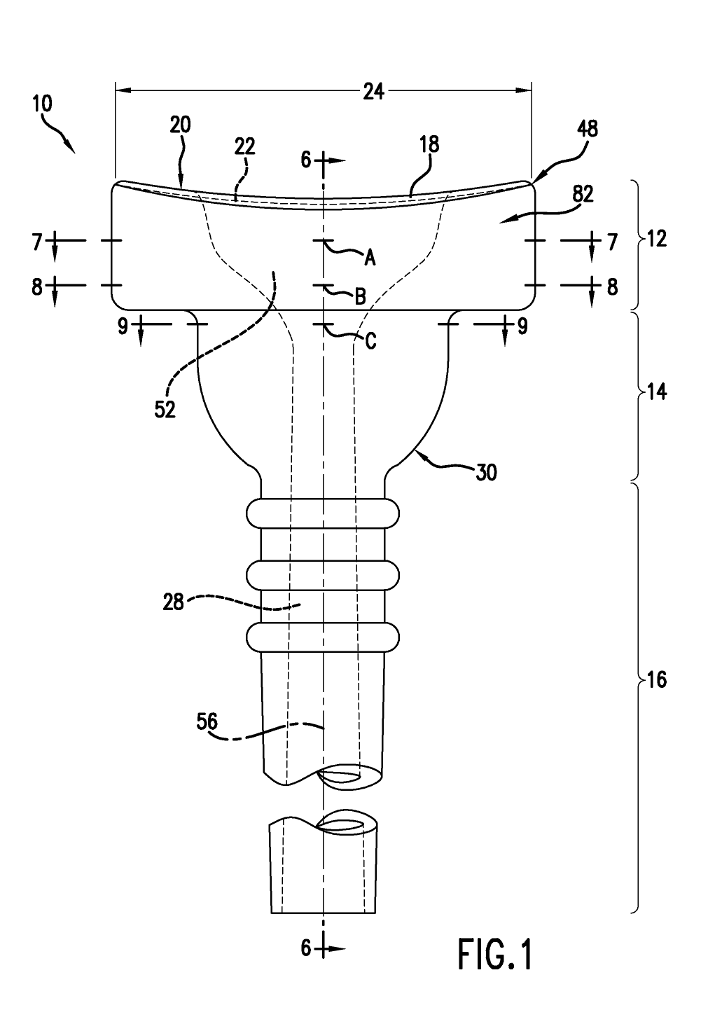

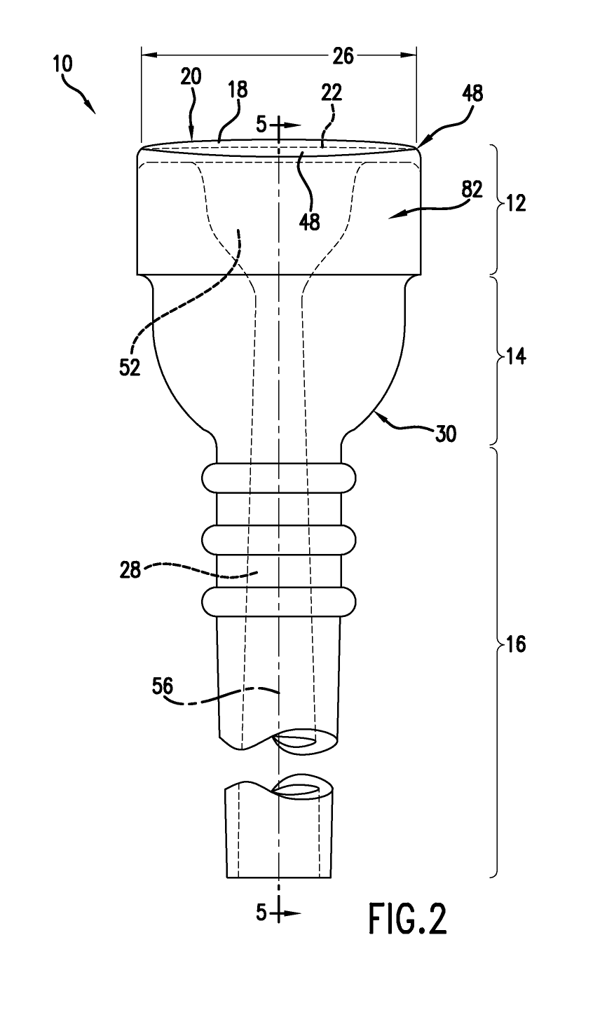

One exemplary embodiment of the mouthpiece 10 is disclosed in FIG. 1. The mouthpiece 10 may be a single, integrally formed piece, or may be a plurality of components that are attached to one another. For purposes of discussion, the mouthpiece 10 has an upper section 12 that is the portion of the mouthpiece 10 that engages the lips of the musician during use. A middle section 14 of the mouthpiece 10 extends from the upper section 12, and a lower section 16 in turn extends from the middle section 14 and is the portion of the mouthpiece 10 farthest from the lips of the user during use. With reference to FIGS. 1-3, the upper section 12 includes a rim 18 that has an end face 20 that forms the upper, terminal end of the mouthpiece 10. The mouthpiece 10 may be made of any type of material such as yellow brass, stainless steel, titanium, plastic, or LEXAN® available from Sabic Innovative Plastics having offices located at One Plastics Avenue, Pittsfield, Mass., 01201, USA.

The rim 18 has an outer perimeter 22 that marks the boundary between the rim 18 and an exterior side wall 82 of the mouthpiece 10. As the lips of the user may engage the rim 18, it is normally the case that a round 48 is located on the perimeter 22 to prevent the presence of a sharp edge that may cut or injure the lips of the user during use. The round 48 may extend along the entire perimeter 22, or may extend only partially around the full length of the perimeter 22 in accordance with various exemplary embodiments. The perimeter 22 may be located at the middle of the round 48, or may be located immediately inboard (on the side towards the longitudinal axis 56) of the round 48, or may be located immediately outboard (on the side of round 48 farthest away from the longitudinal axis 56) of the round 48 in various embodiments.

The outer perimeter 22 may have a major axis 24 and a minor axis 26. The outer perimeter 22 may also have a first major axis side 32 and an oppositely located second major axis side 34. The first major axis side 32 is located between points 84 and 88, and the second major axis side 34 is located between points 86 and 90. The first major axis 24 extends from the first major axis side 32 to the second major axis side 34. The remaining sides of the outer perimeter 22 can be defined as a first minor axis side 36 that is located between points 84 and 86, and a second minor axis side 38 that is located between points 88 and 90. A minor axis 26 extends from the first minor axis side 36 to the second minor axis side 38. Both the major axis 24 and minor axis 26 extend through the longitudinal axis 56.

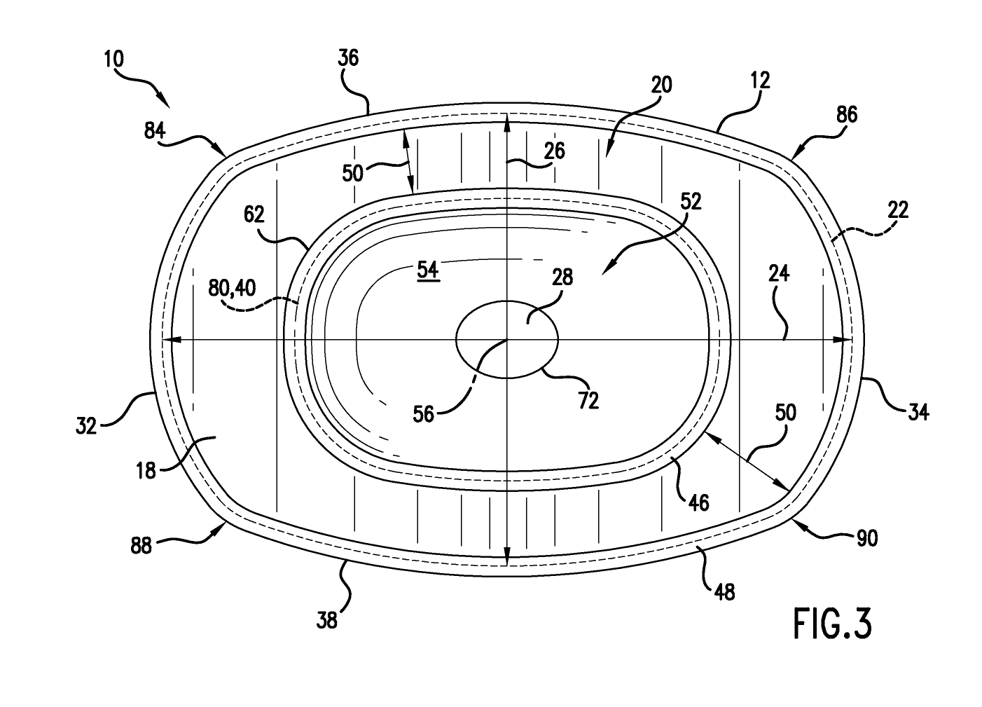

The outer perimeter 22 of the rim 18 may be configured so that the major axis 24 is longer in length than the minor axis 26. This arrangement can be made so that the outer perimeter 22 of the rim 18 is oval shaped. In other exemplary embodiments, the outer perimeter 22 may be oval in shape and the oval may be an ellipse. In some embodiments, the major axis 24 may be 1.25 times, 1.5 times, 1.75 times, 2 times, or up to 10 times longer than the minor axis 26. The outer perimeter 22 may be arranged so that any one or all of the sides 32, 34, 36, and/or 38 are straight or curved. As shown in FIG. 3, all of the sides 32, 34, 36 and 38 have some amount of curvature. It is to be understood that other exemplary embodiments of the mouthpiece 10 exist in which the major axis 24 and the minor axis 26 are of the same length such that the outer perimeter 22 is circular in shape. The outer perimeter 22 may be square shaped or rectangular shaped in accordance with yet other exemplary embodiments.

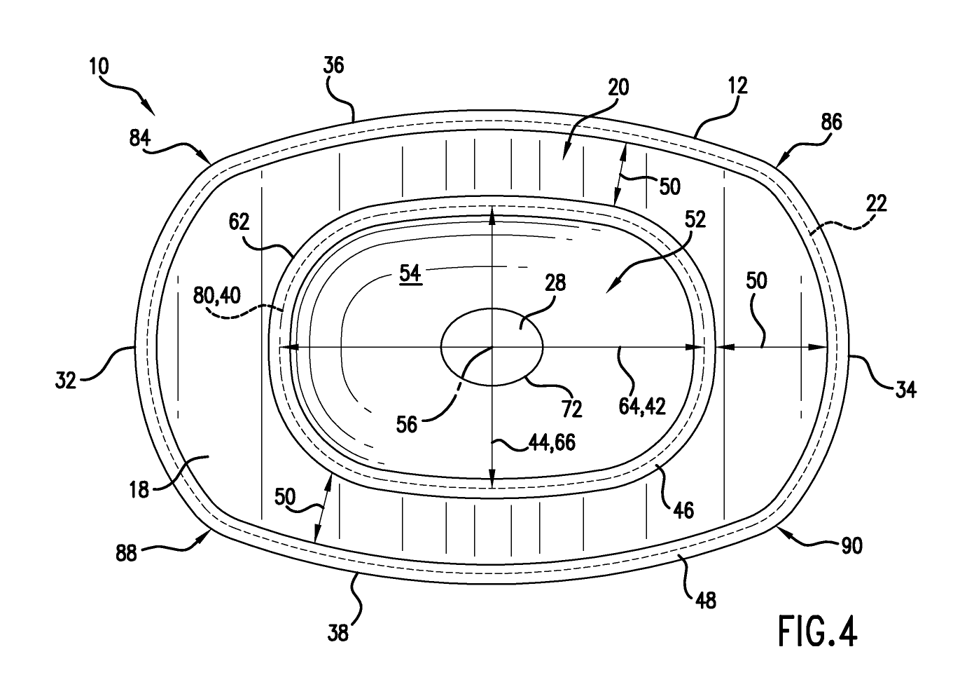

The end face 20 of the rim 18 extends from the outer perimeter 22 to an inner perimeter 40. As such, the end face 20 may be defined between the perimeters 22 and 40. Particulars of the inner perimeter 40 may be described with reference to FIG. 4. As the user may engage the inner perimeter 40 with his or her lips, a round 46 may be located along the entire length of the inner perimeter 40 to eliminate sharp edges. The round 46 may extend along the entire length of the inner perimeter 40 or only along a portion of the length of the inner perimeter 40 in various embodiments. The inner perimeter 40 may be located so that it is in the middle of the round 46, immediately adjacent the round 46 on the side of the round 46 closest to the longitudinal axis 56, or immediately adjacent the round 46 on the side of the round 46 that is farthest from the longitudinal axis 56.

The inner perimeter 40 can be variously shaped. In the embodiment shown, the inner perimeter 40 has a major axis 42 that is coincident with the major axis 24 along a portion of its length. The inner perimeter 40 also includes a minor axis 44 that is coincident with the minor axis 26 along a portion of its length. Both the major axis 42 and the minor axis 44 extend through the longitudinal axis 56 of the mouthpiece 10 and are located at a right angle to one another. The major axis 42 may be sized so that it is longer than the minor axis 44. The major axis 42 may be from 1.25 times, 1.5 times, 1.75 times, 2 times, or up to 10 times longer than the minor axis 44. The proportional differences in length between the axes 24 and 26 of the outer perimeter 22 may be the same as or different from the proportional difference in length between the axes 42 and 44. The inner perimeter 40 can be arranged so that all of the sides of the inner perimeter 40 are curved. Alternatively, some of the sides may be curved and the others straight, and still further, all of the sides of the inner perimeter 40 may be straight in accordance with other exemplary embodiments. The inner perimeter 40 may be arranged so that it is oval in shape. In some embodiments, the inner perimeter 40 may be racetrack oval in shape. In other exemplary embodiments, the inner perimeter 40 may be square or rectangular in shape.

The end face 20 can be arranged so that it lacks a convex portion at certain locations. With reference to FIGS. 3 and 4, a width 50 of the end face 20 is defined so that it extends from the round 46 to the round 48. The width 50 may be the portion of the end face 20 that extends from a point immediately adjacent the round 46 at the side of round 46 farthest from the longitudinal axis 56 to a point immediately adjacent the round 48 that is closest to the longitudinal axis 56, such that the line of the width 50 would if extended extend through the longitudinal axis 56. The width 50 is flat. Various widths 50 are noted in FIGS. 3 and 4, but it is to be understood that additional widths 50 are present and may be arranged 360° around the longitudinal axis 56. Still further, the entire end face 20 surrounding the longitudinal axis 56 may be convex in shape in accordance with other exemplary embodiments. The width 50 is variously sized, as with all other features of the mouthpiece in accordance with other exemplary embodiments. For example, the width 50 may be from 0.01-1 millimeter, from 0.5-2 millimeters, from 1-4 millimeters, or up to 12 millimeters in accordance with various exemplary embodiments. In fact the top rest is normally narrower than the bottom lip rest, and the side support rest is wider than the bottom lip rest

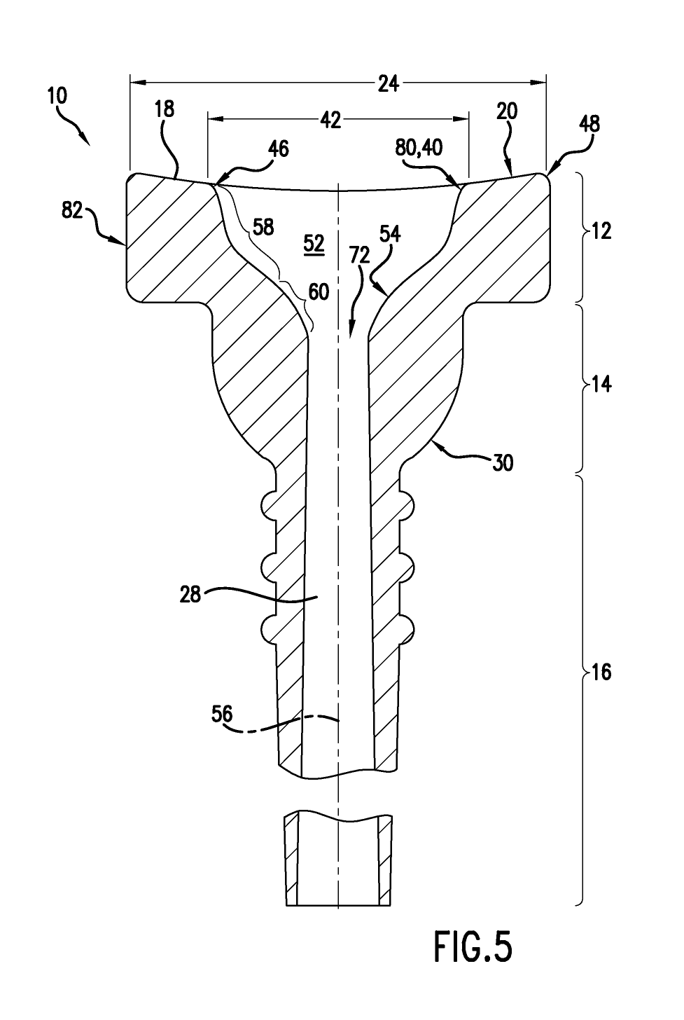

The end face 20 may be configured so that it has a concave shape upon extension from the first major axis side 32 to the second major axis side 34. This concave shape may be more easily seen with reference to FIG. 1 in which the end face 20 reaches a low point at the longitudinal axis 56 and reaches two high points on either end. With reference back to FIG. 3, the low point of the end face 20 may be at the minor axis 26 while the high point is at both the first and second major axis sides 32 and 34. The end face 20 can be concave in shape so that it is completely symmetric about the minor axis 26, and completely symmetric about the major axis 24. The concave portion of the end face 20 may be the entire end face 20 except for any portions of the rounds 46 and 48 that are located in the end face 20. With reference to the cross-sectional view of FIG. 5, the concave shape of the end face 20 may be seen, along with the flat shape of the end face 20 with respect to the width 50 of the end face 20. Given that the surface of the width 50 is normally flat, the player need not curl his/her lips to achieve high notes. This method is quite different in approach than the traditional one. Instead of buzzing curved lips inside the perimeter 46 of the cup 52, the player blows straight through the lips inside the cup 52. The flat surface of the width 50 facilitates an easier buzz supported by the varying widths on the top, bottom and sides of the surface of the width 50.

The mouthpiece 10 may also feature a cup 52 that can be defined by an inner surface 54 of the mouthpiece 10. The cup 52 may be located in the upper section 12 and the middle section 14. It is to be understood that the cup 52 may be located in only the upper section 12, in only the upper and middle sections 12 and 14, or in all of the sections 12, 14 and 16 in accordance with various exemplary embodiments. In embodiments in which the mouthpiece 10 lacks a middle section 14, the cup 52 need not be located in a middle section 14. The cup 52 may be located in any section of the mouthpiece 10 even if such mouthpiece 10 lacks a particular section or has no sections at all. The depth of the cup 52 may be the distance the cup 52 extends in the longitudinal direction along the longitudinal axis 56 from the upper end 80 to the throat 72. The depth of the cup 52 may be varied in accordance with different exemplary embodiments. For example, the cup 52 may have a depth from 0.5-1 millimeter, from 1-10 millimeters, or up to 30 millimeters in accordance with various embodiments. Thus, the cup 52 depth may extend straight down for some distance as opposed to all current mouthpieces that angle inward from edge 46.

The cup 52 has an upper end 80 that is located at the same point as the inner perimeter 40 as shown with reference to FIG. 4. The upper end 80 may be coincident with the inner perimeter 40 such that these two features are essentially a single feature and have the same size and shape as one another. It is to be understood that as used herein, the term “coincident” may mean two features that share the exact same size and location, or it may be the case that one feature such as a line is included within another feature such as a different line that is longer than the first line. The term thus means two features that make up essentially one feature, or two features one of which forms part of a second. The upper end 80 demarcates the boundary between the rim 18 and the cup 52 and the round 46 can be located at the upper end 80 so that the user does not injure his or her lips during use. The upper end 80 may be located in the middle of this round 46 or may be on either side of the round 46 in other embodiments. Further, it is to be understood that the rounds 46 and/or 48 need not be present in accordance with various exemplary embodiments.

The upper end 80 of the cup 52 may thus define a perimeter 62 of the cup 52 which is located at the same location as the inner perimeter 40. The perimeter 62 may have a major axis 64 and a minor axis 66. The perimeter 62 can be variously shaped. The major axis 64 may be coincident with the major axis 24 along a portion of its length, and the minor axis 66 may be coincident with the minor axis 26 along a portion of its length. Both the major axis 64 and the minor axis 66 extend through the longitudinal axis 56 of the mouthpiece 10 and are located at a right angle to one another. The major axis 64 may be sized so that it is longer than the minor axis 66. The major axis 64 may be from 1.25 times, 1.5 times, 1.75 times, 2 times, or up to 10 times longer than the minor axis 66. The perimeter 62 can be arranged so that all of the sides of the perimeter 62 are curved. Alternatively, some of the sides may be curved and the others straight, and still further, all of the sides of the perimeter 62 may be straight in accordance with other exemplary embodiments. The perimeter 62 may be arranged so that it is oval in shape. In some embodiments, the perimeter 62 will be racetrack oval in shape and may also be elliptical in shape. In other exemplary embodiments, the perimeter 62 may be square or rectangular in shape.

The cup 52 extends downward from the upper end 80 in the direction along the longitudinal axis 56. The cup 52 may be discussed in relation to an upper section 58 of the cup 52, and a lower section 60 of the cup 52. The cup 52 terminates at a throat 72 of the mouthpiece 10 that can be located in either the middle section 14, the lower section 16, or may be the point of demarcation between the middle section 14 and lower section 16. Again, it is to be understood that the throat 72 need not be located at a section of the mouthpiece 10, or may be located in a section different from that previously mentioned in other exemplary embodiments of the mouthpiece 10. The throat 72 may simply be the opening of the backbore 28 and thus have essentially no length in the longitudinal direction along the longitudinal axis 56. Alternatively, the throat 72 may extend some length in the longitudinal direction along the longitudinal axis 56 from the bottom end of the cup 52 and at some point the throat 72 transitions to the backbore 28 such that this transition can be physically noted upon inspection of the mouthpiece 10 or such that this transition does not have a physical point/line/boundary of demarcation.

The lower section 60 of the cup 52 may extend from the throat 72 to the upper section 58. In turn, the upper section 58 may extend from the lower section 60 to the upper end 80. There need not be a physical boundary line or clear line of distinction between the upper section 58 and the lower section 60. In some embodiments, the size of the cup 52 may become noticeably smaller at a certain point, and this certain point may mark the boundary between the upper section 58 and the lower section 60. However, in yet other arrangements, the size of the cup 52 may decrease/increase gradually or not radically in the longitudinal direction such that no clear boundary line between an upper section 58 and a lower section 60 may be noticed. In such arrangements, the cup 52 may still be thought of as having an upper section 58 and lower section 60 although there is no clear physical boundary marker separating these sections. The perimeter 62 in the lower section 60 may be in some instances larger than the perimeter 62 in the upper section 58. In other arrangements, the perimeter 62 in the lower section 60 may be the same size or smaller than the perimeter 62 of the upper section 58. The perimeter 62 in the upper section 58 may have an oval shape while the perimeter 62 in the lower section 60 has a conical or semi-spherical shape. In other exemplary embodiments, the perimeter 62 in both the upper section 58 and the lower section 60 has an oval shape. At other points, for example anywhere in the backbore 28, the perimeter 62 may be circular in shape.

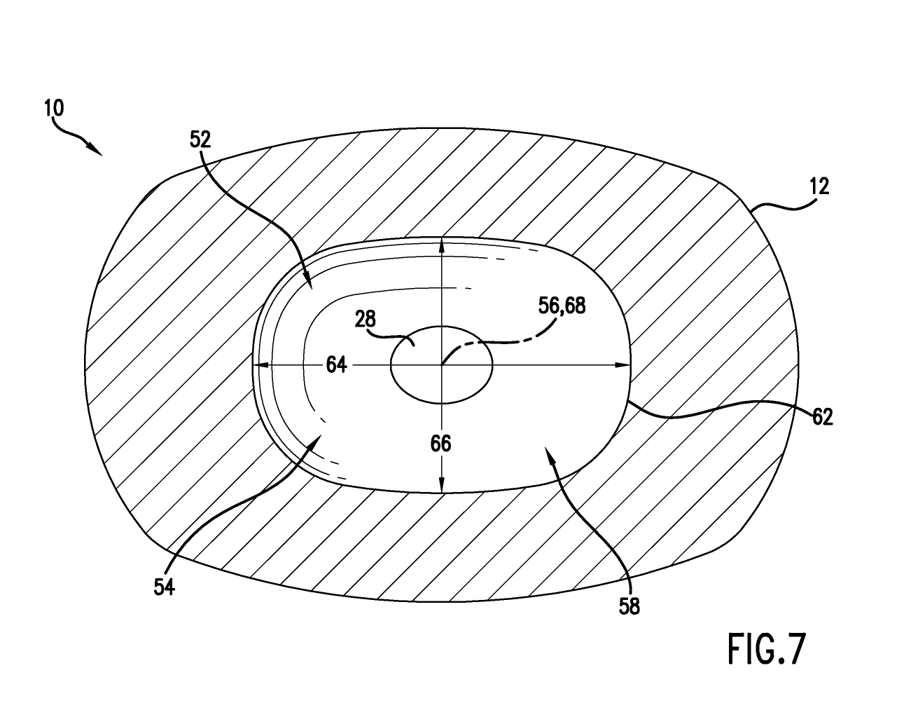

FIG. 7 is a cross-sectional view taken along line 7-7 of FIG. 1 that illustrates the cup 52 in an upper section 58 of the cup 52. The cup 52 is symmetrical and is defined by the inner surface 54 so as to have a perimeter 62. The perimeter 62 includes a major axis 64 and a minor axis 66. The axes 62 and 64 intersect one another at a point of intersection A 68 that is located on the longitudinal axis 56. The axes 62 and 64 may be arranged as previously discussed and a repeat of this information is not necessary. The major axis 64 may be longer than the minor axis 66, and the perimeter 62 can have an oval shape. In most embodiments, the perimeter 62 will be racetrack oval shaped. In other embodiments, the perimeter 62 of the cup 52 may be circular in shape at all locations, or at some of the locations along the longitudinal axis 56.

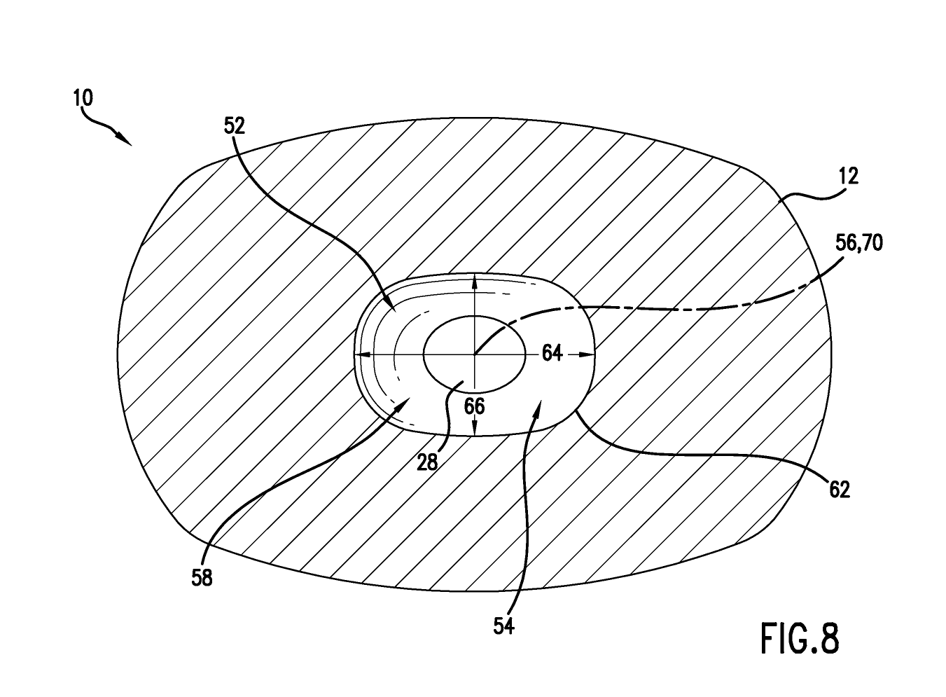

The cup 52 may be arranged so that its perimeter 62 is racetrack oval shaped at all points along the longitudinal axis 56 in which the major axis 64 and minor axis 66 intersect the longitudinal axis 56. In other words, the cup 52 may have an oval cross-sectional shape upon view of planes of the cup 52 sliced perpendicular to the longitudinal axis 56. FIG. 8 shows another cross-sectional view of the mouthpiece 10 taken at a point in the upper section 12 of the cup downward from the cross-section of FIG. 7 along the longitudinal axis 56. The intersection of the major axis 64 and the minor axis 66 is disclosed as being a point of intersection B 70 on the longitudinal axis 56. The perimeter 62 of the cup 52 again has an oval shape. The major axis 64 and minor axis 66 can be configured as those previously described and a repeat of this information is not necessary. However, the major axis 64 in FIG. 8 is smaller than the major axis 64 in FIG. 7 because the cup 52 decreases in size downward along the longitudinal axis 56. Likewise, the minor axis 66 in FIG. 8 is smaller than the minor axis 66 in FIG. 7 because again the cup 52 in the disclosed embodiment has decreased in size upon location along the longitudinal axis 56.

Although only two cross-sections and two points of intersection 68 and 70 are shown, it is to be understood that at all points of intersection along the longitudinal axis 56 in the upper section 58 of the cup 52, the perimeter 62 can have an oval shape. Further, although described as decreasing in size upon moving downward along the longitudinal axis 56, the size of the perimeter 62 need not change. For example, the size and configuration of the perimeter 62 along with the major axis 64 and minor axis 66 at point of intersection B 70 may be the exact same size and configuration as the perimeter 62, major axis 64 and minor axis 66 at the point of intersection A 68. The shape may be the shape of an oval in certain embodiments. The size and configuration of the cup 52 may be the same along any portion of the longitudinal length, or for the entire longitudinal length, of the upper section 58 of the cup 52. In other embodiments, the size of the cup 52 may change at all points upon extending in the longitudinal direction along the longitudinal axis 56. The shape of the perimeter 62 may be the same at all points upon extending in the longitudinal direction along the longitudinal axis 56, or the shape of perimeter 62 may change at these different locations in accordance with other exemplary embodiments of the mouthpiece 10.

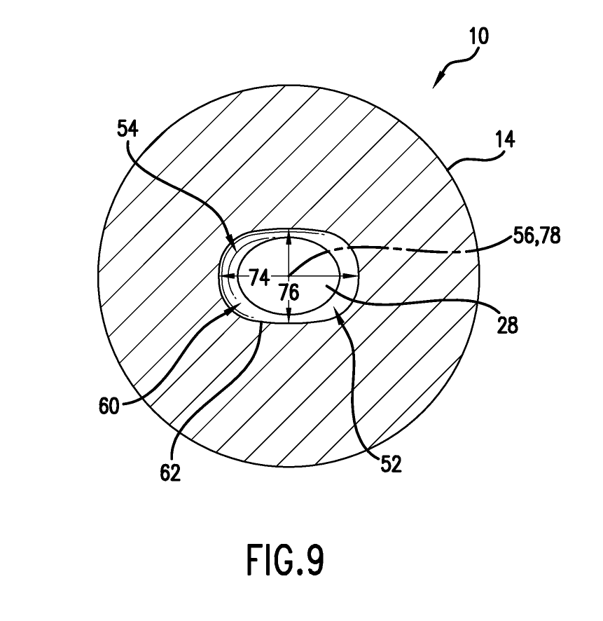

The configuration of the cup 52 in the lower section 60 may be arranged in a similar manner as the cup 52 in the upper section 58. FIG. 9 shows the perimeter 62 of the cup 52 in the lower section 60. The major axis 74 and minor axis 76 intersect one another at a point of intersection C 78 on the longitudinal axis 56. The perimeter 62 in the lower section 60 can be variously shaped. The major axis 74 may be coincident with the major axis 24 along a portion of its length, and the minor axis 76 may be coincident with the minor axis 26 along a portion of its length. Both the major axis 74 and the minor axis 76 extend through the longitudinal axis 56 of the mouthpiece 10 at point of intersection C 78 and are located at a right angle to one another. The major axis 74 may be sized so that it is longer than the minor axis 76. The major axis 74 may be from 1.25 times, 1.5 times, 1.75 times, 2 times, or up to 10 times longer than the minor axis 76. The perimeter 62 can be arranged so that all of the sides of the perimeter 62 are curved. Alternatively, some of the sides may be curved and the others straight, and still further, all of the sides of the perimeter 62 may be straight in accordance with other exemplary embodiments. The perimeter 62 is mostly arranged so that it is racetrack oval in shape. In some embodiments, the perimeter 62 may be an oval in shape. In other exemplary embodiments, the perimeter 62 may be square or rectangular in shape. In yet other arrangements, the perimeter 62 in the lower section 60 may be circular in shape.

The size and configuration of the perimeter 62, major axis 64, and minor axis 66 may be the same or different along all points extending through the longitudinal axis 56 along the entire lower section 60. Further, the size and configuration of the perimeter 62, major axis 64, and minor axis 66 may be the same along all points extending through the longitudinal axis 56 along the entire lower section 60 and upper section 58 in accordance with various exemplary embodiments.

The cup 52 may terminate at a throat 72 that can be shaped and sized the same as the perimeter 62 of the cup 52 at the throat 72, or differently than the perimeter 62 at the throat 72. For example, the perimeter 62 at the bottom of the lower section 60 may be in the shape of an oval, and the throat 72 immediately adjacent the bottom of the lower section 60 may be circular in shape. A sharp boundary line may thus be observed between these two features of the mouthpiece 10. In other arrangements, these two openings may be sized and configured so that they transition gradually into one another.

The lower section 16 of the mouthpiece 10 features a shank and a backbore 28 that extends from the throat 72 to the bottom end of the lower section 16. As such, a through bore is defined through the entire mouthpiece 10 along the longitudinal axis 56. The backbore 28 may be circular in shape and can have the same size along its entire longitudinal length, or may inclined such that its size increases in the longitudinal direction away from the throat 72 and towards the lower end of the lower section 16.

The mouthpiece 10 may have an exterior side wall 82 that defines various features. A cosmetic outer surface 30 may be defined at the middle section 14. In some embodiments, the cosmetic outer surface 30 marks the location of the middle section 14 of the mouthpiece 10. In other arrangements, the cosmetic outer surface 30 is not present. The exterior side wall 82 at the upper section 12 can have rounds that extend in the longitudinal direction and may have an oval perimeter such that the upper section 12 has an exterior surface that is oval shaped. The exterior side wall 82 can be variously arranged so that the external cosmetic or functional features of the mouthpiece 10 are shaped and provided differently in accordance with different exemplary embodiments. The exterior side wall 82 in the upper section 12, middle section 14 and/or lower section 16 may be provided differently from that as disclosed in the figures, and it is to be understood that the disclosed arrangement of the exterior side wall 82 in the figures is only exemplary.

The mouthpiece 10 may be provided with one or all of the aforementioned features. Some of the previously discussed features such as the concave end face 20, the oval shaped outer perimeter 22, and/or the racetrack oval shaped cup 52 perimeter 62 may allow the resulting mouthpiece 10 to be easier to use by the musician and may reduce the practice time needed by the musician. The musician will be able to reach higher notes through the use of one or more of the aforementioned features. The mouthpiece 10 that includes one or more of the features mentioned herein is more comfortable for the user and imparts less fatigue on the embouchure when playing the instrument.

The mouthpiece 10 may be used with any type of musical instrument. The mouthpiece 10 can be used in connection with a brass instrument such as a trumpet, cornet, piccolo trumpet, flugelhorn, French horn, trombone, euphonium, tenor, alto or double horn, baritone, or tuba. In use, the musician may or may not curl in his or her bottom lip and leave the top lip relaxed. The user may place his or her lips onto the end face 20 and then buzz. As the embouchure increases, the musician will allow his or her lower lip to follow the upper lip in a kiss format while blowing (buzzing). The user may continue to buzz while playing the instrument. The mouthpiece 10 may allow the user to reach high notes even if he or she does not have the necessary natural embouchure to do so with other mouthpieces. The mouthpiece 10 may have features, such as an oval outer perimeter 22 and/or an oval inner perimeter 40, that more closely follow the natural form of the user's lips.

In other uses of the mouthpiece 10, the user could use a standard technique to play the instrument. In this regard, the user may curl in his or her top and bottom lips and buzz with them placed against the end face 20. The user may use one third of the upper lip and two thirds of the bottom lip while playing. The user may maintain a tense or firm upper lip to reach higher notes when using the mouthpiece 10 with a standard technique.

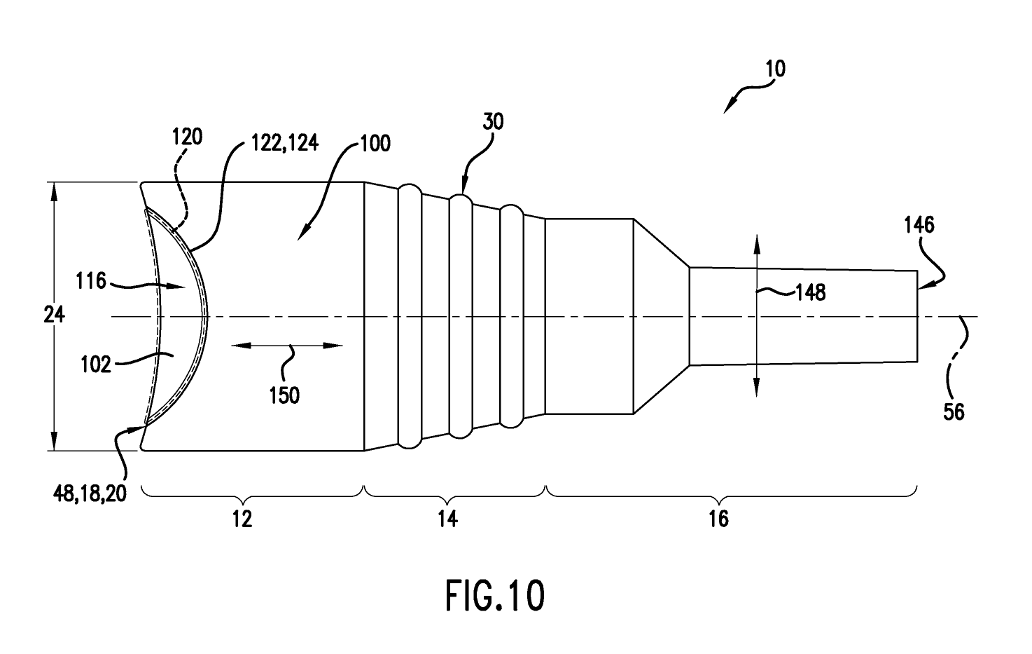

Another exemplary embodiment of the mouthpiece 10 is illustrated with reference to FIG. 10. An outer surface of the mouthpiece 10 includes a side surface 100. The cosmetic outer surface 30 is again included in this embodiment, but it need not be present in other versions of the mouthpiece 10. A first angled section 102 extends from the rim 18 and is defined by a perimeter 120. The first angled section 102 has a shape that resembles a half moon. The perimeter 120 that defines the first angled section 102 may be bound by the side surface 100 and the rim 18 such that these two features completely define the perimeter 120. Some of perimeter 120 overlaps with the outer perimeter 22 of the rim 18. An edge 122 of the first angled section 102 can extend from the rim 18 along the side surface 100 and then back to the rim 18. A first round 124 may be present on the edge 122. The edge of the outer perimeter 120 of the rim 18 may also include a round 48. The first angled section 102 may be designed such that it has a flat upper surface 116. The flat upper surface 116 may be completely flat such that it is not concave or convex, and may extend and be bound completely between the rounds 48 and 124.

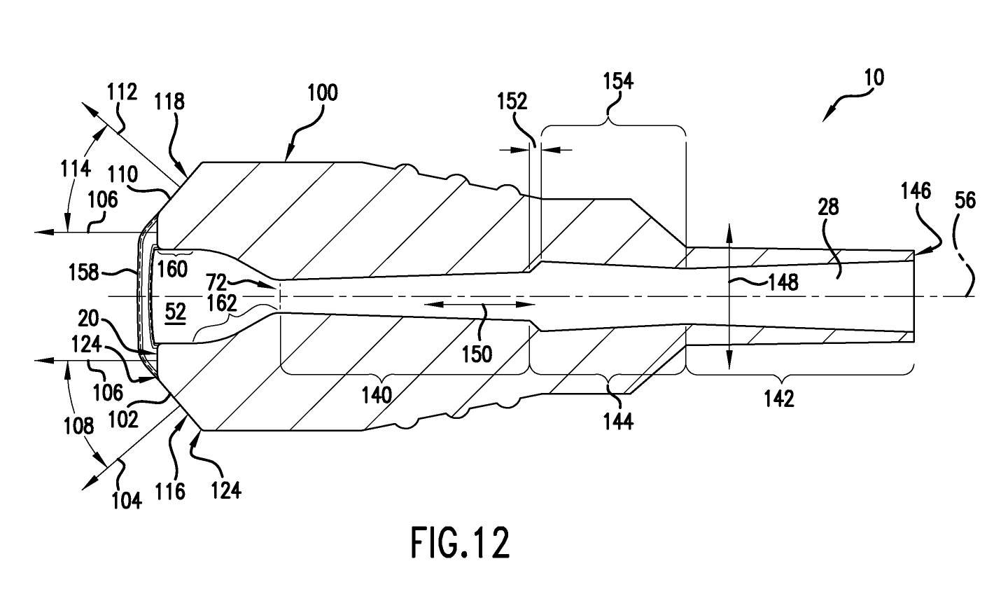

The first angled section 102 is shown in cross-sectional view with reference to FIG. 12. The flat upper surface 116 has a surface normal 104 that extends outwards at a 90 degree angle. A surface normal 106 of the end face 20 of the rim 18 is also illustrated. Surface normal 106 may be located on the same side of the major axis 24 as the surface normal 104, and surface normal 106 may be located on the minor axis 26. An angle 108 is present between the surface normal 104 and 106. Angle 108 may be between 0 degrees and 90 degrees in certain exemplary embodiments. Angle 108 may be 45 degrees in certain exemplary embodiments, or may be from 30 degrees-70 degrees in other exemplary embodiments. The first angled section 102 may thus be oriented at an angle to the end face 20.

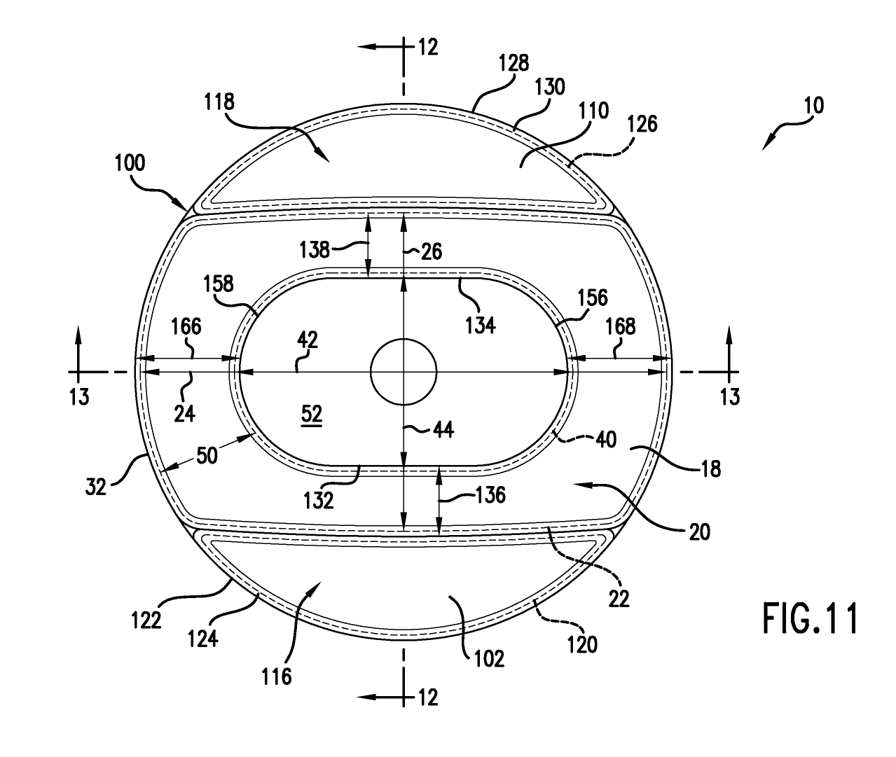

With reference now to FIG. 11, a second angled section 110 is shown on the upper section 12 of the mouthpiece 10. The second angled section 110 may be arranged in the same manner as the first angled section 102. However, the second angled section 110 is on a different side of the rim 18 such that the rim 18 is between the two angled sections 102 and 110. In this regard, the first angled section 102 is on one side of the major axis 24 and the second angled section 110 is on the opposite side of the major axis 24. The second angled section 110 has a flat upper surface 118 that has a surface normal 112. Surface normal 112 may be oriented at an angle 114 with the surface normal 106 of the end face 20 that is on the minor axis 26 and is also on the same side of the major axis 24 as the surface normal 112. The angle 114 may be between 0 degrees and 90 degrees in some exemplary embodiments. In other arrangements, the angle 114 may be 45 degrees, or may be from 30 degrees to 70 degrees.

The second angled section 110 is bound by a perimeter 126 that has a portion that is common with outer perimeter 22. The perimeter 126 also lies along an edge 128 of the second angled section 110. The edge 128 and the outer perimeter 126 may completely bound the second angled section 110 such that they make up the entire perimeter 126. The edge 128 may have a second round 120 that extends along its entire length.

The second angled section 110 may be arranged in the same manner as previously discussed with respect to the first angled section 102, or may be arranged in a different manner. For example, instead of having a perimeter 126 that is semi-circular or moon shaped, the perimeter 126 may be rectangular or circular. The first angled section 102 and/or the second angled section 110 may provide additional support to the lips of the musician when the lips are pressed to the mouthpiece 10. However, this additional support may not limit the movement of the top lip, in particular, and may not restrict tonguing.

With reference to FIG. 11, the inner perimeter 40 may have a shape that is a racetrack round oval with perfectly round corners. The shape of the inner perimeter 40 may not be oval or oval-elliptical in this exemplary embodiment. The inner perimeter 40 may have a first straight segment 132 that is located on a side of the major axis 24. The first straight segment 132 may terminate on either end at a first curved segment 156 and a second curved segment 158 of the inner perimeter 40. The inner perimeter 40 may also have a second straight segment 134 that is located on a side of the major axis 24 opposite that of the first straight segment 132. The second straight segment 134 may terminate at the first and second curved segments 156 and 158. The first and second straight segments 132 and 134 may be parallel to one another, and may also be parallel to the major axis 24.

The first curved segment 156 can have a single radius of curvature so that it is curves between the segments 132 and 134 at a single rate. Likewise, the second curved segment 156 may also have a single radius of curvature so that it is a single, consistent curve along its entire length. The radius of curvature of the first curved segment 156 may be the same as the radius of curvature of the second curved segment 156. The first and second curved segments 156 and 158 may be the same size as one another and completely symmetrical to one another with respect to the minor axis 26. The inner perimeter 40 may be arranged so that it has only these four segments 132, 134, 156 and 158 and no more and no less.

The mouthpiece 10 may also be constructed so that the rim 18 has a different width 50 with respect to different sides of the rim 18 relative to the major axis 24. The first straight segment 132 may be located a distance 136 from the outer perimeter 22 of the rim 18. Distance 136 may be the distance along the minor axis 26 from the first straight segment 132 to the outer perimeter 22 that is located on the same side of the major axis 24 as the first straight segment 132. Distance 136 may be 0.210+/−0.20 inches in certain exemplary embodiments. The distance 136 will vary in accordance with the instrument played. Distance 136 in another embodiment may be the distance defined from the first straight segment 132 to the outer perimeter 22 (that is on the same side of the major axis 24) in a direction parallel to the minor axis 26 along the entire length of the first straight segment 132. This distance 136 may thus represent the distance between the first straight segment 132 and the outer perimeter 22 that is on the same side of the major axis 24 as the first straight segment 132.

The second straight segment 134 may be located a distance 138 from the outer perimeter 22 of the rim 18. Distance 138 may be the distance along the minor axis 26 from the second straight segment 134 to the outer perimeter 22 that is located on the same side of the major axis 24 as the second straight segment 134. Distance 138 may be 0.140+/−0.15 inches in certain exemplary embodiments. Distance 138 in another embodiment may be the distance defined from the second straight segment 134 to the outer perimeter 22 (that is on the same side of the major axis 24) in a direction parallel to the minor axis 26 along the entire length of the second straight segment 134. This distance 138 may thus represent the distance between the second straight segment 134 and the outer perimeter 22 that is on the same side of the major axis 24 as the second straight segment 134.

The first distance 136 may be greater than the second distance 138. In practice, the upper lip support portion of the rim 18 is narrower than the lower lip support portion of the rim 18 as the distance 138 representing the upper lip support portion is smaller than the distance 136 that represents the lower lip support portion. It is to be understood, however, that the distances 136 and 138 may be the same in accordance with other exemplary embodiments.

The width 50 of the rim may be greater along the major axis 24 than along the minor axis 26. This arrangement can allow for more support along the edge of the mouth. For reference, a distance 166 is shown which is the distance from the inner perimeter 40 to the outer perimeter 22 along the major axis 24 that is on one side of the minor axis 26. Distance 166 may be greater than the first distance 136, and distance 166 may be greater than the second distance 138. Likewise, distance 168 is the distance from the inner perimeter 40 to the outer perimeter 22 along the major axis 24 that is on the opposite side of the minor axis 26 than distance 166. Distance 168 is greater than the first distance 136, and distance 168 is greater than the second distance 138. The distances 166 and 168 may be the same in certain versions of the mouthpiece 10.

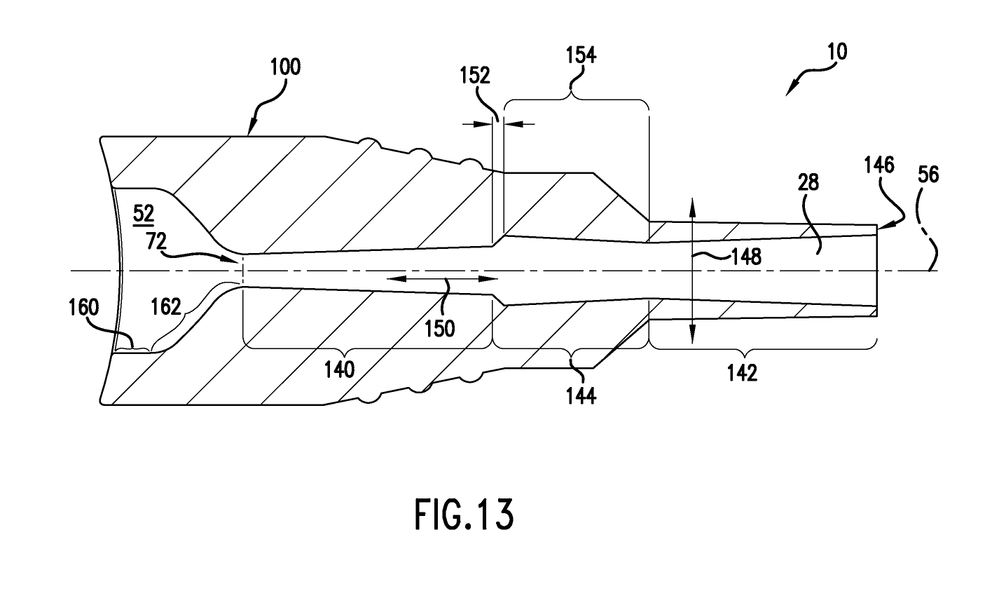

With reference to FIGS. 12 and 13, the cup 52 has a straight section 160 and a curved section 162. The straight section 160 is straight in that it extends from the inner perimeter 40 towards a lower end 146 of the mouthpiece 10 in a longitudinal direction 150. The entire perimeter of the cup 52 is straight and does not curve upon extension from the inner perimeter 40 in the longitudinal direction 150. The straight section 160 may start at the end of a round 46 of the inner perimeter 40 if present. The straight section 160 may have the same racetrack round shape of the inner perimeter 40 along its entire longitudinal length in the longitudinal direction 150.

The length of the straight section 160 in the longitudinal direction 150 may be 0.125 inches in certain exemplary embodiments. However, it is to be understood that the longitudinal length of the straight section 160 may be variously sized in accordance with other arrangements. The straight section 160 may be arranged so that it is not inclined or otherwise extend in the radial direction 148 along its entire length in the longitudinal direction 150. The cup 52 may also have a curved section 162 that begins at the end of the straight section 160. The curved section 162 may decrease in size in the radial direction 148 upon extension away from the straight section 160 in the longitudinal direction 150. The curved section 162 may be inclined, convex, concave, or any combination of these shapes in accordance with various exemplary embodiments. As shown in FIGS. 12 and 13, the curved section 162 has a concave shape, then an inclined shape, and finally a convex shape upon extension away from the straight section 160 in the longitudinal direction 150. The curved section 162 may terminate at the throat 72 which may also demarcate the end of the cup 52. The curved section 162 may transition in cross-sectional shape from a racetrack round shape at the straight section 160 to a circular cross-sectional shape at the throat 72.

The linear arrangement of the straight section 160 that extends in the longitudinal direction 150 promotes a sharp, crisp tone during use of the mouthpiece 10. Although described as linear, it is to be understood that the straight section 160 may be curved. The straight section 160 is linear in that it does not move towards or away from the longitudinal axis 56 in the radial direction 148 upon extension from the rim 18 to the curved section 162 in the longitudinal direction 150.

The inner surface 54 defines the cup 52 and the backbore 28. The cup 52 terminates at the throat 72, and the backbore 28 extends from the throat 72 away from the cup 52 in the longitudinal direction 150. The backbore 28 includes a first segment 140 that extends from the throat 72 in the longitudinal direction 150. The first segment 140 extends in the radial direction 148 upon extension away from the throat 72 and towards the lower end 146 in the longitudinal direction 150. The first segment 140 may expand at a first rate in the radial direction along its entire length in the longitudinal direction 150. In other arrangements, the first segment 140 need not expand in the radial direction 148 but may maintain the same size in the radial direction 148 along its entire length in the longitudinal direction 150.

The backbore 28 may include a tone enhancer 144 that can be located halfway, that is between the throat 72 and the lower end 146, in the longitudinal direction 150 of the backbore 28. The tone enhancer 144 portion of the backbore 28 may provide better tone quality during use of the mouthpiece 10. The tone enhancer 144 has a tone enhancer first portion 152 that extends from the first segment 140 in the longitudinal direction 150. The tone enhancer first portion 152 extends at a second rate in the radial direction 148 upon extension in the longitudinal direction 150 away from the first segment 140. The second rate is larger than the first rate. In this regard, the tone enhancer first portion 152 expands faster in the radial direction 148 than does the first segment 140 per the same extension in the longitudinal direction 150. The length of the tone enhancer first portion 152 may be less than the length of the first segment 140 in the longitudinal direction 150.

The tone enhancer 144 also includes a tone enhancer second portion 154 that extends away from the tone enhancer first portion 152 in the longitudinal direction 150 towards the lower end 146. The tone enhancer second portion 154 contracts in the radial direction 148 upon extension away from the tone enhancer first portion 152 in the longitudinal direction 150. The tone enhancer second portion 154 may contract in the radial direction 148 along its entire length in the longitudinal direction 150, and in certain exemplary embodiments may contract at the same rate along its entire length in the longitudinal direction 150. The length of the tone enhancer second portion 154 in the longitudinal direction 150 may be longer than the length of the tone enhancer first portion 152 in the longitudinal direction 150. Although described as having two portions 152 and 154, the tone enhancer 144 may have but a single portion 152 in other exemplary embodiments, or may have from 3-10 portions in still further exemplary embodiments of the mouthpiece 10.

The backbore 28 may also include a second segment 142 that extends from the tone enhancer second portion 154 in the longitudinal direction 150 towards the lower end 146. The second segment 142 expands in the radial direction 148 along its entire length in the longitudinal direction 150. However, in other arrangements, the second segment 142 may maintain a constant size in the radial direction 148 along its entire length, or may decrease in size in the radial direction 148 at one or more portions along its longitudinal length. The second segment 142 may increase in size in the radial direction 148 at the first rate, and thus at the same rate of increase as the first segment 140. Although the exemplary embodiment shows the first and second segments 140 and 142 increasing in size in the radial direction 148 at the same rate upon extension in the longitudinal direction 150 towards the lower end 46, this need not be the case in other exemplary embodiments.

The tone enhancer 144 may be located 1.75 inches from the lower end 46 in the longitudinal direction 150. The tone enhancer 144 can be located at the halfway point of the backbore 28 in the longitudinal direction 150. In other arrangements, the tone enhancer 144 need not be located at the halfway point of the backbore 28 in the longitudinal direction 150. The cross-sectional shape of the backbore 28 may be circular along its entire length in the longitudinal direction 150. As such, the first segment 140, second segment 142, tone enhancer first portion 152, and tone enhancer second portion 154 may be circular in cross-sectional shape along their entire lengths in the longitudinal direction 150.

The backbore 28 may be the smallest size in the radial direction at throat 72 (or position D). The size of the backbore 28 at the throat 72 may be from 3.5 millimeters to 3.9 millimeters (for trumpet use) and the throat may have a circular cross-sectional shape. However, all or a portion of the backbore 28 may have a cross-sectional shape that is not circular in other embodiments. For example, all or a portion of the backbore 28 may have an oval shape.

The length of the major axis 42 of the inner perimeter 40 may be 11/16^{th} of an inch, and the length of the minor axis 44 of the inner perimeter 40 may be ⅜^{th} of an inch in accordance with certain exemplary embodiments. In other embodiments, major axis 42 may be 13/16^{th} of an inch, and minor axis 44 may be ½ of an inch. Various sizes may be made between these two versions such that 1/32 of an inch increases in the major axis 42 and the minor axis 44 (from the version where the distances are 11/16^{th} of an inch and ⅜^{th} of an inch) are provided.

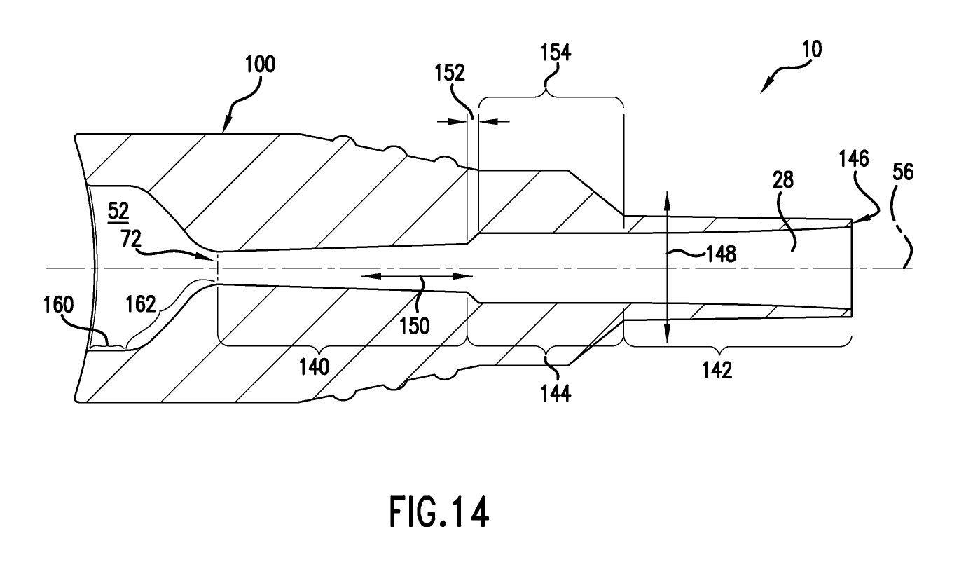

An alternative exemplary embodiment of the mouthpiece 10 is shown in FIG. 14. The mouthpiece 10 may be arranged in the same manner as previously discussed and a repeat of this information is not necessary. The mouthpiece 10 in FIG. 14 differs from that illustrated with reference to FIG. 13 in that the tone enhancer second portion 154 remains the same in radial size along its entire length from the tone enhancer first portion 152 to the second segment 142. The backbore 28 at the second segment 142 may then increase in radial size upon extension away from the tone enhancer second portion 154.

The variously described configurations of the mouthpiece 10 may provide for a better quality and consistent sound when using the mouthpiece 10 during play.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A mouthpiece for a musical instrument, comprising:
an upper section, wherein a cup is at least partially defined by the upper section, wherein the upper section has a rim that has an end face, wherein a first angled section extends from the rim to a side surface of the upper section.

2. The mouthpiece as set forth in claim 1, where the rim has an outer perimeter that has a major axis and a minor axis, wherein the major axis of the outer perimeter of the rim is greater in length than the minor axis of the outer perimeter of the rim, wherein the first angled section is defined between the outer perimeter of the rim and the side surface of the upper section, wherein a surface normal of the end face located at the minor axis is oriented at an angle that is between 0 degrees and 90 degrees to a surface normal of the first angled section.

3. The mouthpiece as set forth in claim 2, wherein the upper section has a second angled section that extends from the rim to the side surface of the upper section, wherein the rim is located between the first angled section and the second angled section, wherein the surface normal of the end face located at the minor axis is oriented at an angle that is between 0 degrees and 90 degrees to a surface normal of the second angled section.

4. The mouthpiece as set forth in claim 3, wherein the first angled section has a flat upper surface, and wherein the second angled section has a flat upper surface;
wherein a perimeter of the first angled section extends between the first angled section and the rim, and wherein the perimeter of the first angled section extends between the first angled section and the side surface of the upper section, wherein an edge of the first angled section along the perimeter of the first angled section between the first angled section and the side surface of the upper section has a first round; and
wherein a perimeter of the second angled section extends between the second angled section and the rim, and wherein the perimeter of the second angled section extends between the second angled section and the side surface of the upper section, wherein an edge of the second angled section along the perimeter of the second angled section between the second angled section and the side surface of the upper section has a second round.

5. The mouthpiece as set forth in claim 1, wherein the rim has an outer perimeter that has a major axis and a minor axis, wherein the major axis of the outer perimeter of the rim is greater in length than the minor axis of the outer perimeter of the rim, wherein the rim has an inner perimeter that has a major axis and a minor axis, wherein the major axis of the inner perimeter of the rim is greater in length than the minor axis of the inner perimeter of the rim;
wherein the inner perimeter has a first straight segment and a second straight segment that are on opposite sides of the major axis of the outer perimeter of the rim, wherein a first distance is defined along the minor axis of the outer perimeter of the rim from the first straight segment to the outer perimeter of the rim on one side of the major axis of the outer perimeter of the rim, wherein a second distance is defined along the minor axis of the outer perimeter of the rim from the second straight segment to the outer perimeter of the rim on the opposite side of the major axis of the outer perimeter of the rim, wherein the first distance is longer than the second distance, thus giving it a racetrack oval shape.

6. The mouthpiece as set forth in claim 5, wherein the distance from the first straight segment to the outer perimeter of the rim on one side of the major axis of the outer perimeter of the rim is greater than the distance from the second straight segment to the outer perimeter of the rim on an opposite side of the major axis of the outer perimeter of the rim along a line parallel to the minor axis of the outer perimeter of the rim across the entire length of the first straight segment.

7. A mouthpiece for a musical instrument, comprising:
an inner surface that defines a cup and a backbore, wherein a longitudinal axis extends through the cup and the backbore, wherein the backbore has a first segment and a second segment and a tone enhancer located between the first segment and the second segment, wherein the second segment terminates at a lower end of the mouthpiece, wherein at least a portion of the tone enhancer extends at a greater radial rate along the longitudinal axis away from the first segment and is larger in a radial direction than at least a portion of the first segment.

8. The mouthpiece as set forth in claim 7, wherein the cup terminates at a throat and wherein the first segment of the backbore extends from the throat, wherein the tone enhancer is located at a halfway point in the longitudinal direction between the throat and the lower end of the mouthpiece.

9. The mouthpiece as set forth in claim 8, wherein the first segment extends at a first rate in the radial direction upon extension away from the cup in the longitudinal direction, wherein the second segment extends at the first rate in the radial direction upon extension away from the tone enhancer in the longitudinal direction, wherein the tone enhancer has a tone enhancer first portion that extends at a second rate in the radial direction upon extension away from the first segment in the longitudinal direction, wherein the second rate is greater than the first rate.

10. The mouthpiece as set forth in claim 9, wherein the tone enhancer has a tone enhancer second portion that decreases in size in the radial direction upon extension away from the tone enhancer first portion in the longitudinal direction, wherein the tone enhancer second portion engages the second segment.

11. The mouthpiece as set forth in claim 9, wherein the tone enhancer has a tone enhancer second portion that remains the same in size in the radial direction upon extension away from the tone enhancer first portion in the longitudinal direction, wherein the tone enhancer second portion engages the second segment.

12. The mouthpiece as set forth in claim 7, further comprising an outer surface that defines a rim, wherein the outer surface has a side surface, wherein the rim and the side surface define a first angled section, and wherein the rim and the side surface define a second angled section, wherein the rim is located between the first angled section and the second angled section.

13. A mouthpiece for a musical instrument, comprising:
an upper section, wherein a cup is defined by an inner surface of the mouthpiece and is at least partially located at the upper section, wherein the upper section has a rim that has an end face, wherein the rim has an outer perimeter that has a major axis and a minor axis, wherein the major axis of the outer perimeter of the rim is greater in length than the minor axis of the outer perimeter of the rim, wherein the rim has an inner perimeter that has a major axis and a minor axis, wherein the major axis of the inner perimeter of the rim is greater in length than the minor axis of the inner perimeter of the rim;
wherein the inner perimeter has a first straight segment and a second straight segment that are both completely parallel to the major axis of the inner perimeter, wherein the inner perimeter has a first curved segment and a second curved segment that have the same radius of curvature that is consistent through the entire lengths of the first and second curved segments, wherein the first straight segment engages both the first and second curved segments, and wherein the second straight segment engages both the first and second curved segments.

14. The mouthpiece as set forth in claim 13, wherein the mouthpiece has a longitudinal axis, wherein the cup has a straight section that extends from the rim in the longitudinal direction such that the cup has the same size in a radial direction upon extension away from the rim in the longitudinal direction along the entire longitudinal length of the straight section, wherein the cup has a curved section that decreases in size in the radial direction upon extension away from the straight section in the longitudinal direction.

15. The mouthpiece as set forth in claim 14, wherein the inner perimeter has a round that extends along the entire length of the inner perimeter.

16. The mouthpiece as set forth in claim 13, wherein the upper section has a first angled section that is defined between the rim and a side surface, wherein upper section has a second angled section that is defined between the rim and the side surface, wherein the rim is located between the first angled section and the second angled section;
wherein a first distance is defined along the minor axis of the outer perimeter of the rim from the first straight segment to the outer perimeter of the rim on one side of the major axis of the outer perimeter of the rim, wherein a second distance is defined along the minor axis of the outer perimeter of the rim from the second straight segment to the outer perimeter of the rim on the opposite side of the major axis of the outer perimeter of the rim, wherein the first distance is longer than the second distance.

17. The mouthpiece as set forth in claim 13, wherein the cup terminates at a throat and wherein a first segment of a backbore extends from the throat in the longitudinal direction and extends at a first rate in the a radial direction upon extension away from the cup in the longitudinal direction;
wherein the backbore has a tone enhancer that has a tone enhancer first portion that extends at a second rate in the radial direction upon extension away from the first segment in the longitudinal direction, wherein the second rate is greater than the first rate, wherein the tone enhancer has a tone enhancer second portion that decreases in size in the radial direction upon extension away from the tone enhancer first portion in the longitudinal direction;
wherein the backbore has a second segment that extends away from the tone enhancer second portion in the longitudinal direction, wherein the second segment extends at the first rate in the radial direction upon extension away from the tone enhancer second portion in the longitudinal direction.

18. The mouthpiece as set forth in claim 13, wherein the distance from the inner perimeter of the rim to the outer perimeter of the rim along the major axis of the outer perimeter of the rim on one side of the minor axis of the outer perimeter of the rim is greater than the distance from the inner perimeter of the rim to the outer perimeter of the rim along the minor axis of the outer perimeter of the rim on one side of the major axis of the outer perimeter of the rim.
